(19) United States
(12) Patent Application Publication
(10) Pub. No.: US 2026/0034502 A1
(43) Pub. Date: Feb. 5, 2026

(54) STAGED-FEED POST-COMBUSTION CO2 CAPTURE TECHNOLOGY FOR A FLUE GAS STREAM

(71) Applicant: University of Kentucky Research Foundation, Lexington, KY (US)

(72) Inventors: Kunlei Liu, Lexington, KY (US); Heather Nikolic, Stamping Ground, KY (US); Reynolds Frimpong, Lexington, KY (US); Fan Zhen, Parsippany, NJ (US)

(21) Appl. No.: 19/355,903

(22) Filed: Oct. 10, 2025

Related U.S. Application Data
(63) Continuation of application No. 19/149,784.
(60) Provisional application No. 63/440,598, filed on Jan. 23, 2023.

(51) Int. Cl. B01D 53/14; B01D 53/18; B01D 53/62; B01D 53/79; B01D 53/96

(52) U.S. Cl. CPC B01D 53/1475; B01D 53/1425; B01D 53/1493; B01D 53/185; B01D 53/62; B01D 53/79; B01D 53/96; B01D 2252/204; B01D 2257/504; B01D 2258/0283

(57) ABSTRACT

An apparatus for capturing carbon dioxide (CO₂) from a gas stream includes an absorber having (a) a flue gas inlet and (b) a staged CO₂-lean amine absorbent inlet, including a first inlet and a second inlet at different levels of the absorber. The apparatus also includes: a stripper, including a staged CO₂-rich amine absorbent inlet having a third inlet and a fourth inlet; a first pump and first conduit system adapted for delivering CO₂-rich amine absorbent from a CO₂-rich amine absorbent outlet in the absorber to the staged CO₂-rich amine absorbent inlet; and a second pump and second conduit system adapted for delivering a CO₂-lean amine absorbent from a CO₂-lean amine absorbent outlet in the stripper to the staged CO₂-lean amine absorbent inlet.

### RELATED APPLICATIONS

This application is a continuation of U.S. patent application Ser. No. 19/149,784, filed Jul. 21, 2025, which claims priority to International Patent Application No. PCT/US2024/012494, filed Jan. 23, 2024, which claims the benefit of U.S. Provisional Patent Application Ser. No. 63/440,598, filed on Jan. 23, 2023, the full disclosures of which are hereby incorporated by reference in their entirety.

### TECHNICAL FIELD

This document relates generally to an apparatus and method for carbon dioxide (CO₂) capture from a gas stream, such as flue gas, by means of (a) staged absorbent regeneration, (b) staged absorber feed applied through spray nozzles inside the absorber, (c) heat integration with reboiler condensate return, (d) control of the absorber temperature profile for a low temperature at the bottom of the packing, and (e) elimination of an additional flue gas feed blower via increasing the back pressure of gas turbine and application of in-duct direct contact cooling with existing plant ductwork when applied to a natural gas combined cycle (NGCC) flue gas. Such an approach advantageously allows for (i) high CO₂ capture efficiency (e.g. 95+%) with (ii) minimal absorbent degradation and energy penalty, (iii) maximized CO₂-rich loading of the absorbent leaving the absorber, (iv) reduced solvent regeneration energy requirement, and (v) improved overall plant efficiency.

### BACKGROUND

The cleanup of acid gasses, such as CO₂, from natural gas, other fossil-fuel based combustion, and other point sources has been an extensively practiced technology. The industrial removal of CO₂ from flue gases dates back to the 1930's. While several technologies exist for the removal of acid gasses, one of the most employed practices is the use of aqueous amines. In this process the amine reacts with the CO₂ to form a carbamate or bicarbonate salt along with a protonated amine to balance the overall charge.

The application of CO₂ capture to low CO₂ concentration point sources, such as natural gas combined cycle (NGCC) flue gas separation has recently been an area of major concern. Due to the maturity of aqueous amine carbon capture systems, this technology will remain the preferred method when new regulations require widespread full-scale deployment of post-combustion carbon capture systems for reducing emissions from fossil fuel combustion. Thus, the market for natural gas carbon capture technologies could be enormous. Natural gas is currently the largest single source of the US electricity generation, at about 38% in 2021. Use of natural gas for electricity production is increasing, as use of coal is decreasing. Although burning natural gas for energy results in just over half the CO₂ emissions than burning coal, this is still significant. About 117 pounds of CO₂ are produced per million British thermal units (MMBtu) equivalent of natural gas compared with more than 200 pounds of CO₂ per MMBtu of coal.

### SUMMARY

In accordance with the purposes and benefits described herein, a new and improved apparatus/process is provided for capturing carbon dioxide (CO₂) from a gas stream. That apparatus comprises, consists of or consists essentially of: (a) an absorber having a flue gas inlet and a staged CO₂-lean amine absorbent inlet, including a first inlet and a second inlet at different levels of the absorber, (b) a stripper including a staged CO₂-rich amine absorbent inlet having a third inlet and a fourth inlet at different levels of the stripper, (c) a first pump and first conduit system adapted for delivering CO₂-rich amine absorbent from a CO₂-rich amine absorbent outlet in the absorber to the staged CO₂-rich amine absorbent inlet, and (d) a second pump and second conduit system adapted for delivering a CO₂-lean amine absorbent from a CO₂-lean absorbent outlet of the stripper to the staged CO₂-lean amine absorbent inlet.

In one or more of the many possible embodiments of the apparatus, the apparatus further includes reboilers adapted to provide heat to strip the CO₂ from the rich solvent. In some embodiments, the apparatus includes a cooler adapted for condensing liquids from captured CO₂ discharged from the captured CO₂ outlet.

In at least some embodiments, the second pump and second conduit system includes (a) a first conduit extending from the second pump to the first inlet and (b) a second conduit extending from the reboiler to the second inlet. In some embodiments, the apparatus further includes an auxiliary pump adapted for pumping the CO₂-lean amine absorbent from the reboiler to the second inlet. In at least some embodiments, the first pump and first conduit system includes (a) a third conduit extending from the first pump to the third inlet and (b) a fourth conduit extending to the fourth inlet. The fourth conduit may feed the CO₂-rich amine absorbent from the CO₂-rich amine absorbent outlet through the condenser for heat exchange before delivering the CO₂-rich amine absorbent to the fourth inlet.

In one or more of the many possible embodiments of the apparatus, the apparatus includes a cooling system adapted to independently cool (a) a flue gas upstream from the flue gas inlet via direct contacting and (b) the CO₂-lean absorbent being delivered to the first inlet and the second inlet at the different levels of the absorber.

In accordance with yet another aspect, the apparatus may include a control module including a controller and a plurality of temperature sensors wherein the controller is responsive to the plurality of temperature sensors provided at each of the different levels of the absorber to control operation of the cooling system and thereby maintain a desired temperature profile at the different levels of the absorber to enhance rich loading of carbon dioxide from the flue gas to the CO₂-lean amine absorbent and reduce energy requirements for CO₂-lean amine absorbent regeneration in the stripper.

In at least one or more of the many possible embodiments, the controller is adapted to maintain the CO₂-rich amine absorbent in a bottom section of the absorber at a predetermined temperature of about or less than 45° C. depending upon the process operating and ambient conditions. In other embodiments, the controller may be adapted to maintain the CO₂-rich amine absorbent in a bottom section of the absorber at a predetermined temperature of about or less than 35° C.

In some embodiments of the apparatus, the cooling system includes a direct contact water spraying upstream from the flue gas inlet that is adapted to cool the flue gas to a predetermined temperature prior to delivery to the flue gas inlet and the control module further includes a flue gas temperature sensor for monitoring current temperature of the flue gas exiting the direct contact cooler. The direct contact cooler may include (a) a cooling chamber having a flue gas inlet, a cooling water inlet, and a water recycling outlet, (b) a cooling water pump connected to a cooling water source and (c) a recycling pump adapted for returning water to the cooling water source. Still further, the direct contact cooler may further include at least one cooling water sprayer in the cooling chamber that receives cooling water from the cooling water pump.

In at least some embodiments, the cooling system further includes an external powered chiller in the CO₂-rich amine absorbent recycling circuit adapted for recycling a portion of the CO₂-rich amine absorbent to the bottom section of the absorber. Still further, in at least some embodiments, the cooling system includes a separate and independently controller-controlled chiller upstream from each of the first inlet and the second inlet.

In accordance with yet another aspect, a method of capturing CO₂ from a gas stream, comprises, consists of or consists essentially of: (a) delivering a CO₂-lean amine absorbent from a stripper to a staged CO₂-lean amine absorbent inlet in an absorber, (b) transferring, in the absorber, CO₂ from a gas stream to the CO₂-lean amine absorbent and generating a CO₂-rich amine absorbent and a treated gas stream, (c) delivering the CO₂-rich amine absorbent from the absorber to a staged CO₂-rich amine absorbent inlet in the stripper and (d) stripping, in the stripper, CO₂ from the CO₂-rich amine absorbent and generating the CO₂-lean amine absorbent for return to the absorber.

In some embodiments, the staged CO₂-lean amine absorbent inlet includes a first inlet and a second inlet wherein the second inlet is between the first inlet and a treated gas stream outlet in the absorber. The delivering of the CO₂-lean amine absorbent includes delivering (a) a first portion of the CO₂-lean amine absorbent to the first inlet and (b) a second portion of the CO₂-lean amine absorbent to the second inlet. In some embodiments, the staged CO₂-rich amine absorbent inlet includes a third inlet and a fourth inlet wherein the fourth inlet is between the third inlet and a captured CO₂ outlet in the stripper. The delivering of the CO₂-rich amine absorbent includes delivering (a) a first portion of the CO₂-rich amine absorbent to the third inlet and (b) delivering a second portion of the CO₂-rich amine absorbent to the fourth inlet.

The method may also include the step of supplying the second portion of the CO₂-lean amine absorbent from a second reboiler connected to the stripper and adapted to provide heat to strip the CO₂ from the lean solvent from the primary reboiler. In some embodiments, the method may include delivering about 70-90% (in some embodiments about 80%) of the CO₂-lean amine absorbent in the first portion and the remainder of the CO₂-lean amine absorbent in the second portion. In some embodiments, the method may include delivering a first stream of about 50-70% (in some embodiments about 60%) of the CO₂-rich amine absorbent to the third inlet and delivering a second stream of the remainder of the CO₂-rich amine absorbent to the fourth inlet.

In some embodiments, the method may include controlling a temperature profile of the absorber by controlling feed stream temperatures of the first portion and the second portion of the CO₂-lean amine absorbent via cooling water and/or external powered chillers. In some embodiments, the method may include maintaining the first portion at a higher temperature than the second portion. The method may also include maintaining the CO₂-rich amine absorbent in the bottom of the absorber at a temperature at or below 45° C. In other embodiments, the method may also include maintaining the CO₂-rich amine absorbent in the bottom of the absorber at a temperature at or below 35° C.

The method may include the steps of: (a) controlling, by a controller-controlled cooling system including but not limited to cooling water and/or external powered chillers, a current temperature of a CO₂-lean amine absorbent being delivered to different levels of the absorber through the first and second inlets, (b) controlling, by the controller-controlled cooling system, a current temperature of the flue gas being delivered to the flue gas inlet of the absorber, and (c) maintaining a desired temperature profile at the different levels of the absorber to enhance transfer of CO₂ from the flue gas to the CO₂-lean amine absorbent and reduce energy requirements for CO₂-lean amine absorbent regeneration in the stripper.

The method may include controlling, by a controller-controlled cooling system a current temperature of a portion of the CO₂-rich amine absorbent being recycled to a bottom section of the absorber.

The method may include monitoring, by a plurality of temperature sensors, a current temperature of the amine absorbent at different levels of the absorber. Further, the method may include providing a controller-controlled chiller upstream from each of the first and second inlets to allow for independent temperature control of the CO₂-lean amine absorbent being delivered to each of the levels of the absorber. Still further, the method may include cooling the flue gas upstream from the absorber using a direct contact cooler.

In the following description, there are shown and described several embodiments of the apparatus and method for capturing CO₂ from a gas stream. As it should be realized, the apparatus and method are capable of other, different embodiments and their several details are capable of modification in various, obvious aspects all without departing from the apparatus and method as set forth and described in the following claims. Accordingly, the descriptions should be regarded as illustrative in nature and not as restrictive.

### BRIEF DESCRIPTION OF THE DRAWING FIGURES

The accompanying drawing figures incorporated herein by reference and forming a part of the specification, illustrate several aspects of the new and improved carbon capture apparatus and the related method of capturing CO₂ from a flue gas stream and together with the description serve to explain certain principles thereof.

FIG. 1 is a schematic illustration of one possible embodiment of the apparatus for capturing CO₂ from a gas stream.

FIG. 2 is a graph illustrating a typical temperature in the stripper, showing that almost all CO₂ is liberated from the solvent in the bottom half of the stripper by a flat plateau on the temperature profile.

FIG. 3 is a graph illustrating the stage-level CO₂ and H₂O flows, showing that almost all CO₂ is liberated from the solvent in the bottom half of stripper by the high CO₂ flowrate from the top of stripper packing to 14 feet for a total 30 feet of a structured-packing equipped stripper.

FIG. 4 is a graph illustrating the achievable stripper temperature control, estimated by the partial pressures of water to CO₂, P_{H2O}/P_{CO2}, that changing the ratio of CO₂-rich amine absorbent between the first stream of the CO₂-rich amine absorbent to the third inlet and the second stream of the CO₂-rich amine absorbent to the fourth inlet.

Reference will now be made in detail to the present preferred embodiments of the device.

### DETAILED DESCRIPTION

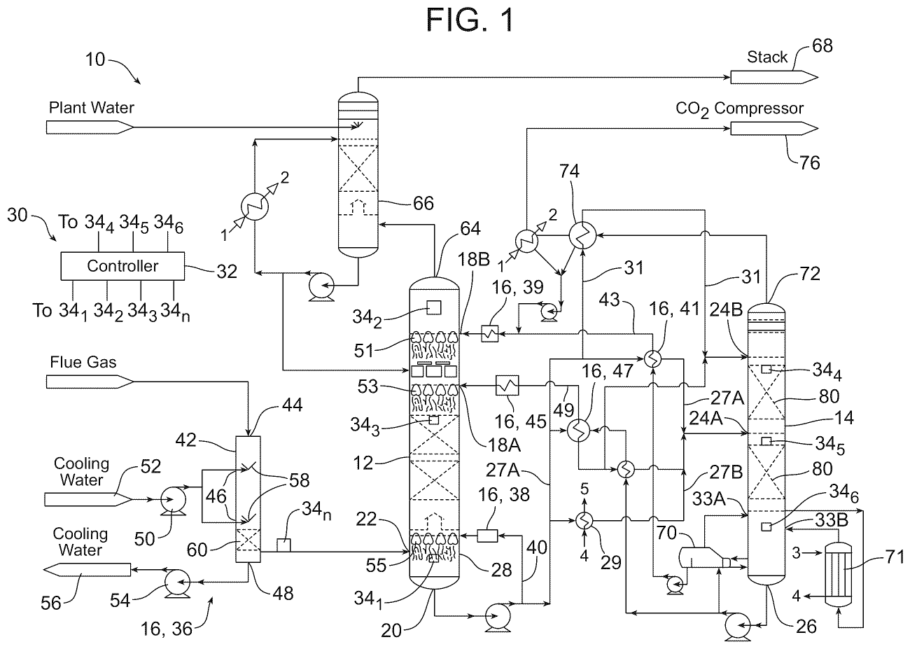

Reference is now made to FIG. 1 which is a schematic illustration of one possible embodiment of the new and improved apparatus 10 for capturing carbon dioxide (CO₂) from a gas stream such as a flue gas stream. The apparatus 10 is adapted to enhance rich carbon loading of a carbon capture solution and thereby minimize absorbent specific reboiler duty during regeneration in the stripper, control the rich CO₂ stream temperatures and flow and their associated vapor contents to reduce the reboiler duty during regeneration in the stripper, and minimize solvent degradation while providing for very high CO₂ capture efficiency. As is known in the art, the carbon capture solution may comprise an amine solvent/absorbent of, for example, primary amines such as monoethanol amine (MEA) or isopropanol amine (1A2P), secondary amines such as piperazine (PZ), or tertiary amines such as methyldiethanolamine (MDEA) or combinations thereof.

As illustrated, the apparatus 10, configured for thermal swing absorption processing, includes an absorber 12, a stripper 14 and a cooling system, generally designated by reference numeral 16. The carbon capture solution or amine absorbent is circulated in a loop between the absorber 12 and the stripper 14 in a manner described in greater detail below.

The absorber 12 includes a staged CO₂-lean absorbent inlet including a first CO₂-lean amine absorbent inlet 18A (first inlet), at an intermediate section of the absorber, and a second CO₂-lean amine absorbent inlet 18B (second inlet) at an upper or top section of the absorber. The absorber 12 also includes a CO₂-rich amine absorbent outlet 20 at the bottom of the absorber and a flue gas inlet 22. The stripper 14 includes a staged CO₂-rich amine absorbent inlet including a CO₂-rich amine absorbent inlet 24A (third inlet) at an intermediate section of the stripper and a CO₂-rich amine absorbent inlet 24B (fourth inlet) at an upper or top section of the stripper. The stripper 14 also includes a CO₂-lean amine absorbent outlet 26. The inlets 24A and 24B are connected to the outlet 20 to allow CO₂-rich carbon capture solution/amine absorbent to be delivered from the absorber 12 to the stripper 14 in a split stream to allow for temperature control of the amine absorbent in the stripper as described in greater detail below. The outlet 26 of the stripper 14 is connected to the inlets 18A and 18B to allow CO₂-lean carbon capture solution/amine absorbent to be delivered from the stripper to the absorber in a split stream as set forth with greater detail below.

The cooling system 16 is adapted to cool at least one of (a) the flue gas upstream from the flue gas inlet 22 and (b) the portion of CO₂ lean streams fed to the first inlet 18B and the second inlet 18A; (c) the portion of the CO₂-rich amine absorbent being recycled to a bottom section 28 of the absorber 12. The bottom section 28 generally refers to the portion of the absorber including the flue gas inlet 22. In at least some embodiments, the bottom section 28 refers to the lowermost 20% to 50% of the absorber 12.

The carbon capture system 10 also includes a control module 30. As illustrated in FIG. 1, the control module 30 includes a controller 32 and a plurality of temperature sensors 34₁-34ₙ. In the illustrated embodiment, the temperature sensor 34₁ is adapted to sense a temperature of the CO₂-rich amine absorbent at the bottom section 28 of the absorber 12. The temperature sensor 34₂ is adapted to sense the temperature of the CO₂-lean amine absorbent at the top section of the absorber 12 adjacent the inlet 18B. The temperature sensor 34₃ is adapted to sense the temperature of the intermediate section of the absorber 12 adjacent the inlet 18A.

The temperature sensor 34₄ is adapted to sense the temperature of the amine absorbent in an upper section of the stripper near the inlet 24B. The temperature sensor 34₅ is adapted to sense the temperature of the amine absorbent in an intermediate section of the stripper 14 near the inlet 24A. The temperature sensor 34₆ is adapted to sense the temperature of the amine absorbent in a lower section of the stripper 14 near the reboiler inlet 33A and the heat exchanger recycling inlet 33B. The temperature sensor 34ₙ is adapted to sense the temperature of the flue gas being delivered to the absorber 12 through the flue gas inlet 22.

The controller 32 is adapted to control the temperature profile of the carbon capture solution in the absorber 12 and maintain the CO₂-rich amine absorbent in the bottom section 28 of the absorber 12 at a predetermined temperature. In many embodiments, that predetermined temperature is less than or equal to 45° C. In still other embodiments, that predetermined temperature is less than or equal to 35° C. This is accomplished by controlling the input temperatures of (a) the CO₂-lean amine absorbent at the inlets 18A and 18B, (b) the portion of the CO₂-rich amine absorbent at the inlet 19 and (c) the flue gas at the inlet 22. Simultaneously, controller 32 is adapted to control the temperature profile of the amine absorbent in the stripper 14. In this way, the stripper 14 operates more efficiently to release previously captured CO₂ and regenerate CO₂-lean amine absorbent from the CO₂-rich amine absorbent received from the absorber 12.

In the illustrated embodiment, the cooling system 16 comprises (a) a direct contact cooler, water spray system, 36 upstream from the flue gas inlet 22 (b) a chiller 38 in a CO₂-rich amine absorbent recycling circuit 40 adapted for recycling a portion of the CO₂-rich amine absorbent to the bottom section 28 of the absorber 12, (c) the chiller 39 and/or heat exchanger 41 in the lean carbon capture line 43 for delivering CO₂-lean amine absorbent from the stripper 14 to the absorber 12 at the inlet 18B and (d) the chiller 45 and/or heat exchanger 47 in the lean carbon capture line 49 for delivering CO₂-lean amine absorbent from the stripper 14 to the absorber 12 at the inlet 18A. The addition of the chillers 39 and 45 further lowers the temperature of the CO₂-lean amine absorbent, being fed to the absorber 12, to the point that it is below that accomplished by just exchanging heat with the lean amine absorbent and even lower than what can be accomplished with cooling water.

As shown in FIG. 1, the direct contact cooler 36 includes a cooling chamber 42 having a flue gas inlet 44, a cooling water inlet 46 (two shown) and a water recycling outlet 48. The direct contact cooler 36 also includes a cooling water pump 50, connected to a cooling water source 52, and a recycling pump 54 adapted for returning water through a cooling tower 56 to the cooling water source 52. Still further, the direct contact cooler 36 includes at least one cooling water sprayer 58 (two shown) in the cooling chamber 42 that receives cooling water from the cooling water pump 50 and sprays that water in a fine mist to efficiently cool the flue gas with which it is in contact. Structured packing 60 may be provided in the cooling chamber 42 to increase the cooling efficiency of the direct contact cooler 36.

The chiller 38 in the CO₂-rich carbon capture solution recycling circuit 40 may be of substantially any type of chiller known in the art and suited or adapted for cooling the portion of the CO₂-rich carbon capture solution being recycled to the bottom section 28 of the absorber 12. That portion may comprise, for example, between about 5 and about 20% percent of the entire amount of CO₂-rich carbon capture solution being pumped by the pump 62 from the bottom of the absorber 12. The independently controller-controlled chillers 39, 45 and heat exchangers 41, 47 for cooling the CO₂-lean amine absorbent may be of any type known in the art to be useful for the intended purpose.

The CO₂-depleted, treated flue gas, is discharged from the absorber 12 at the treated flue gas outlet 64 and passed through a water wash vessel 66 in order to capture any residual carbon capture solution that may remain. That treated flue gas is then discharged back into the atmosphere from the stack 68.

As is known in the art, the stripper 14 includes a reboiler 70, the secondary reboiler, that is operated to provide heat to strip the CO₂ from the CO₂-lean amine absorbent from reboiler 71 and help maintain a desired operating temperature then further regenerate the CO₂-lean amine absorbent, of which the produced gases is then fed to the stripper 14 at the inlet 33A. The reboiler 71, under control of the controller 32, is the primary reboiler that aids in controlling the temperature of the amine absorbent in the stripper by recycling amine absorbent to the stripper 14 at the inlet 33B. The captured CO₂ that is released from the CO₂-rich amine absorbent is discharged from the CO₂ outlet 72 at the top of the stripper 14 and then passed through the condenser 74 to condense portion of residual water vapor. That water vapor is returned to the stripper 14 or absorber 12 while the CO₂ is routed for sequestration or other purposes at 76. The reboiler 70 generates a leaner loading of CO₂-lean amine absorbent for feed to the absorber at 18B than the reboiler 71 for CO₂-lean amine absorbent for feed to the absorber at 18A.

More specifically describing the apparatus 10, the control module 30 includes a controller 32 connected to (a) the first temperature sensor 34₁ in the bottom section 28 of the absorber 12, (b) a second temperature sensor 34₂ in the top section of the absorber 12, (c) a third temperature sensor 34₃ in the intermediate section of the absorber 12, and (d) a fourth temperature sensor 34ₙ′ in the flue gas line 49 between the direct contact cooler 47 and the flue gas inlet 22.

The controller 32, in response to the temperature data received from the temperature sensors 34₁-34ₙ, independently controls operation of: (a) the chiller 39 to continuously control the current temperature of the CO₂-lean amine absorbent to be fed to the upper section of the absorber 12 with a distributor or through spray nozzles 51, (b) the chiller 45 to continuously control the temperature of the CO₂-lean amine absorbent to be fed to the the intermediate section of the absorber with a distributor or through spray nozzles 53, (c) the chiller 38 to continuously control the temperature of the CO₂-rich amine absorbent to be fed to the the lower section of the absorber with a distributor or through spray nozzles 55, and (d) the direct contact cooler 36 to continuously control the temperature of the flue gas delivered to the absorber at the flue gas inlet 22. Advantageously, the independent control set forth above allows the controller 32 to effectively control the temperature profile of the carbon capture absorbent at each level or section of the absorber 12.

As a result of this control, the carbon capture system 10 effectively maintains a desired temperature profile at the different levels of the absorber 12 to enhance rich loading of CO₂ from the flue gas to a carbon capture solution and reduce energy requirements for lean carbon capture solution regeneration in the stripper. This control includes maintaining the CO₂-rich carbon capture solution in a bottom section or lower section 28 of the absorber 12 at a temperature at or below 45° C., or in some embodiments, at or below 35° C. thereby allowing one to optimize the performance of the carbon capture system 10 depending upon the type of carbon capture solution being circulated through the absorber 12 and stripper 14.

The carbon capture apparatus 10 shown in FIG. 1 and described above is useful in a new and improved method of capturing CO₂ from a flue gas. As generally shown in FIG. 1 and outlined above, that method includes the steps of: (a) controlling, by a controller-controlled cooling system 16, a current temperature of a CO₂-lean amine absorbent being delivered to different levels of an absorber 12 through a plurality of lean carbon capture solution inlets 18A, 18B, (b) controlling, by the controller-controlled cooling system, a current temperature of a flue gas being delivered to a flue gas inlet 22 of the absorber; and (c) maintaining a desired temperature profile at the different levels of the absorber to enhance rich loading of CO₂ from the flue gas to a carbon capture solution and reduce energy requirements for lean carbon capture solution regeneration in the stripper 14.

The method may include controlling, by the controller-controlled cooling system 16 a current temperature of a portion of a CO₂-rich amine absorbent being recycled to a bottom section 28 of the absorber 12. Still further, the method may include (a) capturing the CO₂ with a CO₂-lean amine absorbent in the absorber 12 to generate a CO₂-rich amine absorbent, (b) regenerating the CO₂-lean amine absorbent from the CO₂-rich amine absorbent in the stripper 14, and (c) maintaining the CO₂-rich amine absorbent in a bottom section 28 of the absorber at a temperature at or below 45° C. Alternatively, the method may include maintaining the CO₂-rich amine absorbent in a bottom section 28 of the absorber 12 at a temperature at or below 35° C.

As described above and clearly illustrated in the drawing FIG. 1, the method includes monitoring, by a plurality of temperature sensors 34₁, 34₂, 34₃, 34ₙ, a current temperature of the amine absorbent/carbon capture solution at each level of the absorber 12. The method also includes monitoring, by a plurality of temperature sensors 34₄, 34₅, and 34₆ a current temperature of the amine absorbent/carbon capture solution at each level of the stripper 14.

The method also includes providing a controller-controlled chiller 38, 39, 41 upstream from each of the plurality of lean carbon capture solution inlets 18A and 18B to allow for independent temperature control of the CO₂-lean amine absorbent being delivered to the different levels of the absorber 12. The method may also include cooling the flue gas upstream from the absorber 12 using a direct contact cooler 36.

The system 10 and method described above provide a number of benefits and advantages over state-of-the-art carbon capture systems and methods. The system 10 and method involve controlling the temperature profile of the carbon capture solution in the absorber 12 by controlling both the CO₂-lean amine absorbent and flue gas feed stream temperatures at the inlets 18A and 18B, and optionally intercooling of the portion of the CO₂-rich amine absorbent being recycled to the bottom section 28 of the absorber through the recycling circuit 40. In the chiller 38, chilled water may be used to cool the CO₂-rich amine absorbent, which is then sprayed through spray heads 106 over the flue gas entering the absorber through the inlet 22, to remove additional moisture, lowering the wet bulb temperature to less than 30° C. prior to feeding it to the bottom of the absorber packed section 108.

In contrast, in the conventional process, flue gas is cooled in a direct contact cooler to about 43° C. or a few degree below. The absorber temperature profile is generally controlled through the absorbent and gas feed stream temperatures and intercooling of the absorbent in the lower section of the absorber to enhance the driving force for CO₂ absorption. Typical absorber bottom temperatures of amine-based absorbent for coal-based flue gas in the conventional process is about 45 to 55° C. The additional lowering of inlet flue gas wet bulb temperature resulting from the technology described in this document promotes additional rich CO₂ loading of the solvent beyond what is achieved with the conventional absorber configuration.

The reduction in temperature in the bottom section 28 of the absorber 12 enhances CO₂ absorption because of a larger difference between the gas phase CO₂ partial pressure and equilibrium partial pressure of CO₂ resulting from the loading in the carbon capture solution. This leads to an increase in the rich carbon loading of the carbon capture solution at the absorber bottom 28 and the increased carbon loading of the carbon capture solution fed to the stripper 14, resulting in significant energy savings from the lower steam requirements with the technology. Because the energy consumption to regenerate CO₂-lean amine absorbent for the process is significantly reduced from the lower specific reboiler duty, the overall plant efficiency is improved.

By controlling the temperature of the CO₂-rich amine absorbent being delivered to the stripper at the inlets 24A and 24B through the use of the independently controller-controlled heat exchangers 29, 41 and the condenser 74, it is also possible to operate the stripper 14 more efficiently to release previously captured CO₂ and regenerate CO₂-lean amine absorbent from the CO₂-rich amine absorbent received from the absorber 12. The temperature of the CO₂-rich amine fed at 24A is at the vaporization point and two-phase flow, with 1-10% vapor, is fed to the stripper at 24A. The higher temperature and vapor flow fed toward the bottom of the stripper as stripping gases reduces the reboiler 71 duty. The temperature of the CO₂-rich amine fed at 24B is below the vaporization point and one-phase liquid flow under typical operating pressures, is fed to the stripper at 24B. The lower temperature fed toward the top of the stripper reduces the water content on the CO₂ outlet 72 and increases the stripper top to bottom temperature differential resulting in a lower solvent regeneration energy requirement.

### Overall Process

As shown in FIG. 1, this technology includes staged absorbent feeds into the absorber 12 and stripper 14, increasing the CO₂ capture rate while lowering absorbent degradation and energy requirement. In the absorber 12, 70-90% of the absorbent with a carbon to nitrogen (C/N) ratio of 0.22-0.25 is fed to the middle inlet 18B, capturing ˜80% of the CO₂, while 10-30% of absorbent with C/N=0.17-0.20 is fed to the top inlet 18A as a polishing step, capturing the remaining ˜15% of the CO₂. The absorber temperature profile is controlled through the feed stream temperatures, as in the case of intercooling, to enhance the absorption driving force, which results in an effective, short column. The rich absorbent is also split into two streams prior to entering the stripper 14: 40% is introduced through the inlet 24A at the top of the stripper at lower temperature and the remaining 60% is introduced through the inlet 24B in the middle of the column at higher temperature to minimize the overhead stream H₂O/CO₂ content and reduce the required regeneration energy. Heat is recovered from two sources: a) the stripper overhead condenser heat at condenser 74 is used to heat the rich absorbent, reducing absorbent regeneration energy and b) reboiler condensate sensible heat from the reboiler 70 is used to preheat a portion of the rich absorbent to be fed to the stripper. Each further reduces the reboiler specific duty, cooling tower duty, and improves overall plant efficiency. This can be coupled with the UK-developed, machine learning-based feed-forward process control strategy that continuously and automatically minimizes steam extraction while meeting external load changes and maintaining the target CO₂ capture.

Taking advantage of NGCC+HRSG positive pressure operation nature, the flue gas enters the apparatus 10 at about 90° C., 1.05 bar rather than 113° C., 1.0 bar which is assumed for 2019 US Department of Energy reference case B31B, eliminating the need of an additional blower and reducing the cooling tower duty. It is then cooled by co-current, in-duct direct contact 42 (40° C.) and enters the apparatus 10 unit at the bottom of the absorber 12 where 95+% of the CO₂ is captured with staged absorbent feeds. The absorber height is minimized (<40 ft. packing) by maximizing the liquid/gas contact area by utilizing amine absorbent spray and one-stage bubble tray as the top stage-feed for ˜20% lean absorbent flow to remove ˜15% of total CO₂ captured, and by controlling the temperature profile (40-50° C.) with the second stage-feed, ˜80% of lean absorbent flow, and discretized packing. Treated flue gas exits the top of the absorber 12 through the water wash section, achieving <1 ppm amine entrainment and aerosols, and is discharged (44° C., 1 bar). The lean absorbent is fed to the stripper 14 at two points over structured packing 80 to minimize the H₂O: CO₂ vapor ratio at stripper exhaust (the top feed stream) and to reduce the reboiler specific duty by introducing a second vapor stream (middle feed stream).

In the stripper 14, 80% of the absorbent, for instance, is regenerated to a higher lean loading (0.22-0.25 mol C/mol N for a primary amine example) and a smaller amount of absorbent, ˜20%, is regenerated to the extra lean loading (0.17-0.2 mol C/mol N for a primary amine example) required for the high CO₂ capture efficiency, thus minimizing degradation and energy consumption associated with the deeper stripping. A typical rich absorbent loading (2.3-2.5 mol C/kg soln for a primary amine example) is maintained to keep the regeneration energy low. Another unique feature is heat transfer between the rich absorbent and reboiler steam condensate at heat exchanger 29. Furthermore, two-phase flow at the high temperature end of the lean/rich heat exchanger is produced to generate more vapor flow in the middle rich stripper feed 24A, further lowering the reboiler 71 specific duty. Minimizing energy consumption through heat recovery also decreases cooling water duty.

The synergistic effects of the staged absorber feeds with different lean carbon loadings taking advantage of solvent sprays, staged stripper feeds with different temperatures and with/without vapor phase flows, temperature profile control in both the absorber and stripper, heat integration with stripper overhead and reboiler steam condensate return, elimination of the flue gas feed blower, application of in-duct direct flue gas cooling, as well as artificial intelligence (AI)-based feed-forward process control, produces capital and operating cost reductions and improves overall plant efficiency. (1) A low specific reboiler duty reduces the NGCC low pressure (LP) stream extraction, and produces extra electricity. (2) Staged absorber lean feeds coupled with a discretized packing arrangement controls the temperature profile and enhances CO₂ mass transfer, resulting in a shorter packing and total column height. (3) The reduced reboiler condensate temperature after heat transfer to the rich absorbent lowers the heat recovery steam generator flue gas exhaust temperature resulting in lower cooling duty for the in-duct direct contact cooler. Due to the lack of steam extraction to various feedwater heaters in the NGCC steam cycle, the reboiler condensate return will significantly increase the feedwater return temperature, for instance, to 83.89° C. (183° F.) for 2019 US DOE reference case B31B from 38. 89° C. (102° F.) for 2019 US DOE reference case B31A, which results in a high flue gas temperature entering the apparatus 10 island and the need for extra cooling, 110. 56° C. (231° F.) for 2019 US DOE reference case B31B instead of 82.78° C. (181° F.) for 2019 US DOE reference case B31A. (4) The application of in-duct water spray for flue gas cooling takes advantage of existing balance of plant ductwork eliminating the need of a stand-alone direct contact cooler for smaller footprint and lower capital cost. (5) The elimination of additional flue gas blower could provide feasibility for absorber 12 to be installed nearby the flue gas intake point on HRSG resulting significant capital saving on the gas duct connecting existing HRSG and CO₂ capture island.

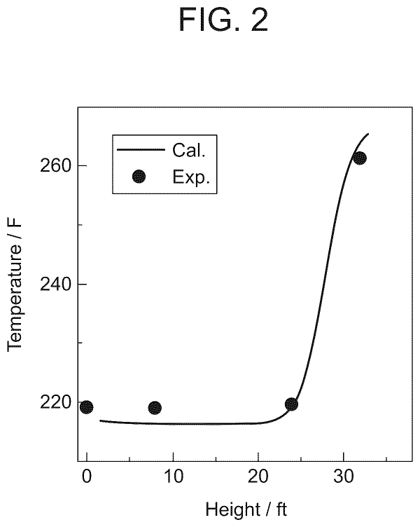

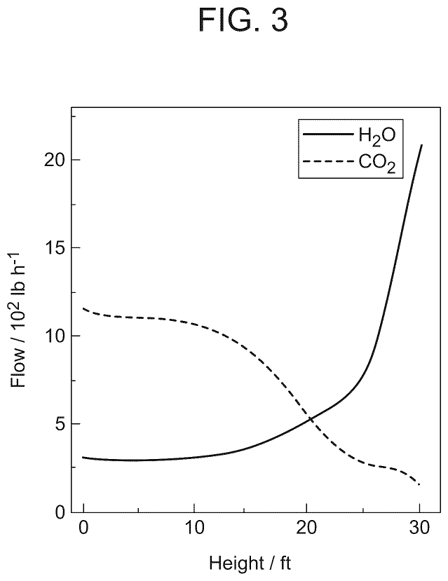

Typical temperature and product CO₂ flow in stripper shown in, FIGS. 2 and 3 clearly show that almost all CO₂ is liberated from the absorbent in the bottom half of stripper 14, illustrated by a flat plateau on the temperature profile, and the high CO₂ flowrate from the bottom of stripper packing to 4.27 meters (14 feet) for a total 9.14 meters (30 feet) of a structured-packing in the stripper.

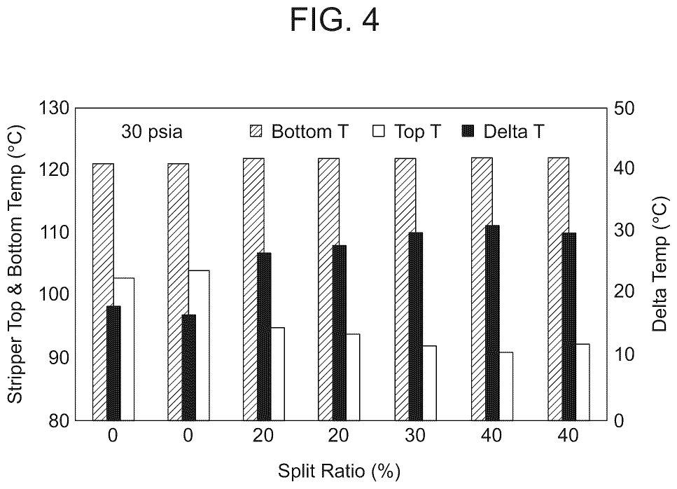

Experiments were performed at different split ratios of CO₂ rich amine feed to the stripper between feeds at 24A and 24B to determine conditions that maximized heat recovery in the stripper 14 with resultant energy savings for the process. The stripper top temperture could be reduced by about 12° C. for split feed ratio of 20-40% compared to no split. A comparison of split-feed and no split tests, FIG. 4, shows from the estimated ratios for the partial pressures of water to CO₂, P_{H2O}/P_{CO2}, that a the split feed can lower the regeneration energy by up to ˜15%.

Using its experimentally-verified Aspen Plus® model, UK has evaluated several CCS configurations when all rich-absorbent related heat exchangers have a log mean temperature difference (LMTD) of 10° C. Table I, conventional absorber with one lean feed, UK absorber with staged lean feeds, and reboiler condensate return heat recovery. With a traditional absorber configuration, one lean feed port at the top of the packing, 95% CO₂ capture can be achieved at relatively extra lean absorbent (C/N=0.17, for example) and high specific reboiler duty (1318 Btu/lb CO₂). With the staged feed strategy set forth in this document, only 20% of absorbent being regenerated to C/N of 0.17, for same of 95% CO₂ capture, the SRD is reduced to 1233 Btu/lb CO₂, followed by further reduction to 1101 Btu/lb CO₂ after a portion of rich absorbent is used to recover the condensate reboiler sensible heat to benefit the NGCC heat recovery steam generator flue gas exhaust temperature. When the LMTD is set at 6° C. (similar to 2019 DOE Reference Case B31B) for all rich absorbent associated heat exchangers, the SRD can drop to 1059 Btu/lb CO₂, which is 12.7% reduction from Canslov, 1213 Btu/lb CO₂, calculated from 2019 DOE Reference Case B12B.

### Table I. Benefit from UK Staged Lean Feeds and Heat Integration

This document may be said to relate to the following items.

1. An apparatus for capturing CO₂ from a gas stream, comprising:
an absorber having (a) a flue gas inlet and (b) a staged CO₂-lean amine absorbent inlet

| | Conventional | Staged Lean | Staged Feeds | |
|---|---|---|---|---|
| Configuration | Absorber | Feeds | with Condensate | |
| Flue Gas Flowrate (kg/hr) | 3600 | | | |
| Cap eff, % | 95 | 95 | 95 | 95 |
| Absprber ID (m) | 0.76 | | | |
| Packing Height (m) | 12 | | | |
| Lean, kg/h | 3590 | 3875 | 3875 | 3875 |
| Carbon Loading in the Leans (C/N) | 0.17 | 20% lean flow at 0.17 and the rest at 0.22 | | |
| Rich Solvent at Absorber Outlet T, ° C. | 44.0 | 42.8 | 42.8 | 42.8 |
| Rich Carbon Loading (C/N) | 0.460 | 0.479 | 0.479 | 0.479 |
| Stripper Operating Pressure (bar) | 2.1 | | | |
| LMTD for Rich Solvent EHXs, ° C. | 10 | 10 | 10 | 6 |
| SRD. btu/lb | 1318 | 1233 | 1101 | 1059 |

including a first inlet and a second inlet at different levels of the absorber;
a stripper including a staged CO₂-rich amine absorbent inlet having a third inlet and a fourth inlet with different flow rates and temperatures;
a first pump and first conduit system adapted for delivering CO₂-rich amine absorbent from a CO₂-rich amine absorbent outlet in the absorber to the staged CO₂-rich amine absorbent inlet; and
a second pump and second conduit system adapted for delivering a CO₂-lean amine absorbent from a CO₂-lean amine absorbent outlet in the stripper to the staged CO₂-lean amine absorbent inlet.
   2. The apparatus of item 1, further including a reboiler adapted to liberate CO₂ and deliver CO₂ lean solvents at the third end of the stripper.
   3. The apparatus of item 2, wherein the second pump and second conduit system includes (a) a first conduit extending from the second pump to the first inlet and (b) a second conduit extending from the reboiler to the second inlet.
   4. The apparatus of item 3, further including an auxiliary pump adapted for pumping the CO₂-lean amine absorbent from the reboiler to the second inlet.
   5. The apparatus of item 4, wherein the first pump and first conduit system includes (a) a third conduit extending from the first pump to the third inlet and (b) a fourth conduit extending to the fourth inlet.
   6. The apparatus of item 5, further including a condenser, adapted for condensing liquids from captured CO₂ discharged from the captured CO₂ outlet.
   7. The apparatus of item 6, wherein the fourth conduit feeds the CO₂-rich amine absorbent from the CO₂-rich amine absorbent outlet through the condenser for heat exchange before delivering the CO₂-rich amine absorbent to the fourth inlet.
   8. The apparatus of any of items 1-7, further including a cooling system adapted to independently cool (a) a flue gas upstream from the flue gas inlet and (b) the CO₂-lean absorbent being delivered to the first inlet and the second inlet, and (3) a portion of CO₂ rich solvent recycling back to absorber.
   9. The apparatus of item 8, further including a control module including a controller and a plurality of temperature sensors wherein the controller is adapted to (a) receive data from the first plurality of temperature sensors provided at the different levels of the absorber, (b) control operation of the cooling system, and (c) maintain a desired temperature profile at the different levels of the absorber to enhance rich loading of carbon dioxide from the flue gas to the CO₂-lean absorbent and reduce energy requirements for CO₂-lean absorbent regeneration in the stripper.
   10. The apparatus of item 9, wherein the controller is adapted to maintain a CO₂-rich absorbent in a bottom section of the absorber at a predetermined temperature less than or about 45° C.
   11. The apparatus of item 9, wherein the controller is adapted to maintain the CO₂-rich absorbent in the bottom section of the absorber at a predetermined temperature less than or about 35° C. for the applications to gas streams with low CO₂ concentration, of below about 6 vol %.
   12. The apparatus of item 9, wherein the cooling system includes a direct contact cooler upstream from the flue gas inlet that is adapted to cool the flue gas to a predetermined temperature prior to delivery to the flue gas inlet and the control module further includes a flue gas temperature sensor for monitoring current temperature of the flue gas exiting the direct contact cooler.
   13. The apparatus of item 12, wherein the direct contact cooler includes (a) a cooling chamber having a flue gas inlet, a cooling water inlet, and a water recycling outlet, (b) a cooling water pump connected to a cooling water source and (c) a recycling pump adapted for returning water to the cooling water source.
   14. The apparatus of item 13, wherein the direct contact cooler further includes at least one cooling water sprayer in the cooling chamber that receives cooling water from the cooling water pump.
   15. The apparatus of item 9, wherein the cooling system further includes a chiller in a CO₂-rich absorbent recycling circuit adapted for recycling a portion of the CO₂-rich absorbent to the bottom section of the absorber.
   16. The apparatus of item 9, wherein the cooling system includes a separate and independently controller-controlled chiller upstream from the first inlet and the second inlet.
   17. The apparatus of item 9, wherein the control module further includes a second plurality of temperature sensors provided at different levels of the stripper and the controller is adapted to (a) receive data from the second plurality of temperature sensors and (b) maintain a desired temperature profile at the different levels of the stripper to improve stripper operating efficiency.
   18. A method of capturing CO₂ from a gas stream, comprising:
delivering a CO₂-lean amine absorbent from a stripper to a staged CO₂-lean amine absorbent inlet in an absorber;
transferring CO₂ from the gas stream to the CO₂-lean amine absorbent and generating a CO₂-rich amine absorbent and a treated gas stream;
delivering the CO₂-rich amine absorbent from the absorber to a staged CO₂-rich amine absorbent inlet in the stripper; and
stripping, in the stripper, CO₂ from the CO₂-rich amine absorbent and generating the CO₂-lean amine absorbent for return to the absorber.
   19. The method of item 18, wherein the staged CO₂-lean amine absorbent inlet includes a first inlet and a second inlet wherein the second inlet is between the first inlet and a treated gas stream outlet in the absorber and the delivering of the CO₂-lean amine absorbent includes delivering (a) a first portion of the CO₂-lean amine absorbent to the first inlet and (b) a second portion of the CO₂-lean amine absorbent to the second inlet.
   20. The method of item 19, wherein the staged CO₂-rich amine absorbent inlet includes a third inlet and a fourth inlet wherein the fourth inlet is between the third inlet and a captured CO₂ outlet in the stripper and the delivering of the CO₂-rich amine absorbent includes delivering (a) a first portion of the CO₂-rich amine absorbent to the third inlet and (b) delivering a second portion of the CO₂-rich amine absorbent to the fourth inlet.
   21. The method of item 20, further including supplying the second portion of the CO₂-lean amine absorbent from a reboiler connected to the stripper and adapted to prevent amine absorbent from settling in the stripper.
   22. The method of item 21, further including delivering about 80% of the CO₂-lean amine absorbent in the first portion and about 20% of the CO₂-lean amine absorbent in the second portion.
   23. The method of item 22, further including delivering about 60% of the CO₂-rich amine absorbent to the third inlet and delivering about 40% of the CO₂-rich amine absorbent to the fourth inlet.
   24. The method of item 23, further including controlling a temperature profile of the absorber by controlling feed stream temperatures of the first portion and the second portion of the CO₂-lean amine absorbent.
   25. The method of item 24, further including maintaining the first portion of the CO₂-rich amine absorbent at a higher temperature than the second portion of the CO₂-rich amine absorbent.
   26. The method of item 18, including maintaining the CO₂-rich carbon capture solution in a bottom section of the absorber at a temperature at about or below 45° C.
   27. The method of item 18, including maintaining the CO₂-rich carbon capture solution in a bottom section of the absorber at a temperature at about or below 35° C. for the applications to gas streams with low CO₂ concentration, of below about 6 vol %.
   28. The method of any of items 18-27, including:
controlling, by a controller-controlled cooling system, a current temperature of the CO₂-lean carbon capture solution being delivered to different levels of an absorber through the first inlet and the second inlet;
controlling, by the controller-controlled cooling system, a current temperature of a flue gas being delivered to a flue gas inlet of the absorber; and
maintaining a desired temperature profile at the different levels of the absorber to enhance rich loading of carbon dioxide from the flue gas to the CO₂-lean amine absorbent and reduce energy requirements for CO₂-lean amine absorbent regeneration in the stripper.
   29. The method of item 28, including controlling, by a controller-controlled cooling system a current temperature of a portion of the CO₂-rich carbon capture solution being recycled to a bottom section of the absorber.
   30. The method of item 29, further including monitoring, by a plurality of temperature sensors, a current temperature of the CO₂-lean amine absorbent and the CO₂-rich amine absorbent at each level of the absorber.
   31. The method of item 30, further including providing a controller-controlled chiller upstream from the first inlet and the second inlet to allow for independent temperature control of the CO₂-lean amine absorbent being delivered to each of the levels of the absorber.
   32. The method of item 31, further including cooling the flue gas upstream from the absorber using a direct contact cooler.
   33. The method of item 28, including monitoring, by a second plurality of temperature sensors, a current temperature of amine absorbent at different levels of the stripper.
   34. The method of item 33, further including maintaining a desired temperature profile at different levels of the stripper to enhance operating efficiency of the stripper.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “an inlet”, as used herein, may also refer to, and encompass, a plurality of inlets.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the apparatus and method of this disclosure have been illustratively described and presented by way of specific exemplary embodiments, and examples thereof, it is evident that many alternatives, modifications, or/and variations, thereof, will be apparent to those skilled in the art. For example, while the staged CO₂-lean amine absorbent inlet, illustrated in FIG. 1 and described above, includes inlets 18A and 18B, it should be appreciated that it could include any number of additional inlets. Similarly, while the staged CO₂-rich amine absorbent inlet, illustrated in FIG. 1 and described above, includes inlets 24A and 24B, it should be appreciated that it could include any number of additional inlets. Accordingly, it is intended that all such alternatives, modifications, or/and variations, fall within the spirit of, and are encompassed by, the broad scope of the appended claims.

What is claimed:

1. An apparatus, comprising:
a point source generating a flue gas including carbon dioxide; and
a carbon capture system downstream from the point source, wherein the flue gas is fed directly from the point source to the carbon capture system.

2. The apparatus of claim 1, in absence of a boost fan between the point source and the carbon capture system to convey the flue gas.

3. The apparatus of claim 2, wherein the point source includes a gas turbine.

4. The apparatus of claim 3, wherein the carbon capture system includes a direct contact cooler.

5. The apparatus of claim 4, wherein the carbon capture system further includes an absorber and a stripper.

6. The apparatus of claim 5, wherein the absorber includes a flue gas inlet and a staged carbon dioxide-lean amine absorbent inlet including a first inlet and a second inlet at different levels of the absorber.

7. The apparatus of claim 6, wherein the stripper includes a staged carbon dioxide-rich amine absorbent inlet having a third inlet and a fourth inlet with different flow rates and temperatures.

8. The apparatus of claim 7, further including a first pump and first conduit system adapted for delivering carbon dioxide-rich amine absorbent from a carbon dioxide-rich amine absorbent outlet in the absorber to the staged carbon dioxide-rich amine absorbent inlet; and a second pump and second conduit system adapted for delivering a carbon dioxide-lean amine absorbent from a carbon dioxide-lean amine absorbent outlet in the stripper to the staged carbon dioxide-lean amine absorbent inlet.

9. A method of capturing carbon dioxide from a point source generating a flue gas including carbon dioxide, comprising:
combusting, at the point source, natural gas or other fossil fuel and generating the flue gas including carbon dioxide; and
feeding the flue gas including carbon dioxide directly from the point source to a downstream carbon capture system in absence of a boost fan to convey the flue gas.

10. The method of claim 9, further including increasing back pressure of a gas turbine of the point source and applying direct contact cooling to the flue gas.

11. The method of claim 9, further including at the downstream carbon capture system, delivering a carbon dioxide-lean amine absorbent from a stripper to a staged carbon dioxide-lean amine absorbent inlet in an absorber; transferring carbon dioxide from the gas stream to the carbon dioxide-lean amine absorbent and generating a carbon dioxide-rich amine absorbent and a treated gas stream; delivering the carbon dioxide-rich amine absorbent from the absorber to a staged carbon dioxide-rich amine absorbent inlet in the stripper; and stripping, in the stripper, carbon dioxide from the carbon dioxide-rich amine absorbent and generating the carbon dioxide-lean amine absorbent for return to the absorber.

12. The method of claim 11, wherein the staged carbon dioxide-lean amine absorbent inlet includes a first inlet and a second inlet wherein the second inlet is between the first inlet and a treated gas stream outlet in the absorber and the delivering of the carbon dioxide-lean amine absorbent includes delivering (a) a first portion of the carbon dioxide-lean amine absorbent to the first inlet and (b) a second portion of the carbon dioxide-lean amine absorbent to the second inlet.

13. The method of claim 12, wherein the staged carbon dioxide-rich amine absorbent inlet includes a third inlet and a fourth inlet wherein the fourth inlet is between the third inlet and a captured carbon dioxide outlet in the stripper and the delivering of the carbon dioxide-rich amine absorbent includes delivering (a) a first portion of the carbon dioxide-rich amine absorbent to the third inlet and (b) delivering a second portion of the carbon dioxide-rich amine absorbent to the fourth inlet.

14. The method of claim 13, further including supplying the second portion of the carbon dioxide-lean amine absorbent from a reboiler connected to the stripper and adapted to supply heat to strip carbon dioxide from the lean absorbent.

15. The method of claim 14, further including directly feeding flue gas to a direct contact cooler via increased back pressure exhaust from the point source without installation of a flue gas boost fan between the point source and the downstream carbon capture system.

16. The method of claim 15, wherein the direct contact cooler is applied within an existing flue gas duct and/or a connecting duct between flue gas intake points.

17. The method of claim 16, further including controlling a temperature profile of the absorber by controlling feed stream temperatures of the first portion and the second portion of the carbon dioxide-lean amine absorbent.

18. The method of claim 17, further including maintaining the first portion of the carbon dioxide-rich amine absorbent at a higher temperature than the second portion of the carbon dioxide-rich amine absorbent.

19. The method of claim 18, further including maintaining the carbon dioxide-rich carbon capture solution in a bottom section of the absorber at a temperature at about or below 45° C.

20. The method of claim 19, further including maintaining the carbon dioxide-rich carbon capture solution in a bottom section of the absorber at a temperature at about or below 35° C. for the applications to gas streams with low carbon dioxide concentration, of below about 6 vol %.
